(19) United States
(12) Patent Application Publication
(10) Pub. No.: US 2003/0033849 A1
(43) Pub. Date: Feb. 20, 2003

(54) Electronic speedometer calibration device

(76) Inventors: Jeffrey J. LaBuy, Green Lake, WI (US); Jerry B. Byng, Oshkosh, WI (US)

Correspondence Address: Donald J. Ersler, 725 Garvens Avenue, Brookfield, WI, 53005, US

(21) Appl. No.: 09/932,143

(22) Filed: Aug. 17, 2001

(51) Int. Cl. G01P 21/00

(52) U.S. Cl. 73/1.37

(57) ABSTRACT

An electronic speedometer calibration device includes a microcontroller and an entry device. The microcontroller receives an electrical speed signal from the speed sensor. The microcontroller is instructed to change the frequency of the electrical speed signal by some multiplication factor. The multiplication factor may be entered through a keypad, a computer download, or through any other suitable device. The multiplication factor is preferably shown on a display device. The multiplication factor may be greater than or less than one. The microcontroller will output an electrical speed signal to the electronic speedometer with a frequency which has been modified by the multiplication factor. The speedometer will display the corrected speed. A second embodiment of the electronic speedometer calibration device includes a digital frequency multiplier and a digital frequency divider. A third embodiment of the electronic speedometer calibration device includes a frequency to voltage converter, variable gain amplifier, and voltage to frequency converter.

### BACKGROUND OF THE INVENTION

1. Field of the Invention

The present invention relates generally to electronic speedometers and more specifically to an electronic speedometer calibration device which may be used to correct the inaccuracy introduced by changing the gear ratio of a motor vehicle drive system.

2. Discussion of the Prior Art

There appears to be no device available for correcting the speed displayed on a speedometer which receives an electrical signal speed signal from a sensor; this appears to be true whether the motor vehicle is an automobile, truck, motorcycle, or all-terrain vehicle. The sensor usually picks up the rotation of a gear in the transmission and sends the electrical speed signal to the speedometer. However, if the gear ratio of the motor vehicle drive system is modified or the tire size is changed; the electric speed signal will be changed from that set at the factory. Further, many motor vehicle manufacturers will have the speedometer display a speed which is slightly faster than reality. The increased speed may also give an inaccurate mileage reading. Namely, the mileage will also be higher than reality.

Accordingly, there is a clearly felt need in the art for a electronic speedometer calibration device which may be used to compensate for the inaccuracy introduced by changing the gear ratio of a motor vehicle, changing tire size, or correcting an erroneously calibrated factory speedometer and odometer.

### SUMMARY OF THE INVENTION

The present invention provides an electronic speedometer calibration device which is capable of modifying the sensor signal. The electronic speedometer calibration device preferably includes a microcontroller and an entry device. The microcontroller receives an electrical speed signal from the speed sensor. The microcontroller is instructed through a software program to change the frequency of the electrical speed signal by some multiplication factor which is determined by the user. The multiplication factor may be entered through a keypad, a computer download, or through any other suitable device. The multiplication factor is preferably shown on a display device. The multiplication factor may be greater than or less than one. The microcontroller will output an electrical speed signal to the electronic speedometer with a frequency which has been changed in proportion to the multiplication factor. The electronic speedometer will display the corrected speed.

A second embodiment of the electronic speedometer calibration device includes a digital frequency multiplier, a digital frequency divider, a multiplier dip switch, and a divider dip switch. The multiplier dip switch defines a multiplication factor to which the frequency is multiplied in the digital frequency multiplier. The divider dip switch defines a division factor to which the frequency is divided in the digital frequency divider. The electrical speed signal is preferably first input into the digital frequency multiplier. The frequency of the electrical speed signal is multiplied by the number set on the multiplier dip switch. The output of the digital frequency multiplier is input into the digital frequency divider. The output of the digital frequency multiplier is divided by the number set on the divider dip switch. The final multiplier factor is the multiplier number set on the multiplier dip switch divided by the divider number set on the divider dip switch. Finally, the output of the digital frequency divider is input by the electronic speedometer and the corrected speed will be displayed.

A third embodiment of the electronic speedometer calibration device includes a frequency to voltage converter, variable gain amplifier, and voltage to frequency converter. The electrical speed signal is input into the frequency to voltage converter. A proportional voltage is output from the frequency to voltage converter into the variable gain amplifier. The gain of the variable amplifier may be varied from a fractional multiplier factor to one which is greater than one. The proportional voltage as multiplied by the gain of the variable gain amplifier is input into the voltage to frequency converter. The voltage to frequency converter transforms the proportional voltage into a proportional frequency. The proportional frequency is input by the electronic speedometer and the corrected speed will be displayed.

Accordingly, it is an object of the present invention to provide an electronic speedometer calibration device which may be used to compensate for the inaccuracy introduced by changing the gear ratio of a motor vehicle drive system.

It is a further object of the present invention to provide an electronic speedometer calibration device which may be used to compensate for the inaccuracy introduced by changing the tire size of a motor vehicle.

Finally, it is another object of the present invention to provide an electronic speedometer calibration device which may be used to correct an erroneously factory calibrated electronic speedometer and odometer.

These and additional objects, advantages, features and benefits of the present invention will become apparent from the following specification.

### BRIEF DESCRIPTION OF THE DRAWINGS

FIG. 1 is a schematic diagram of an electronic speedometer calibration device in accordance with the present invention.

FIG. 2 is a schematic diagram of a second embodiment of an electronic speedometer calibration device in accordance with the present invention.

FIG. 3 is a schematic diagram of a third embodiment of an electronic speedometer calibration device in accordance with the present invention.

FIG. 4 is an electrical schematic of a variable gain amplifier of a third embodiment of an electronic speedometer calibration device in accordance with the present invention.

### DETAILED DESCRIPTION OF THE PREFERRED EMBODIMENTS

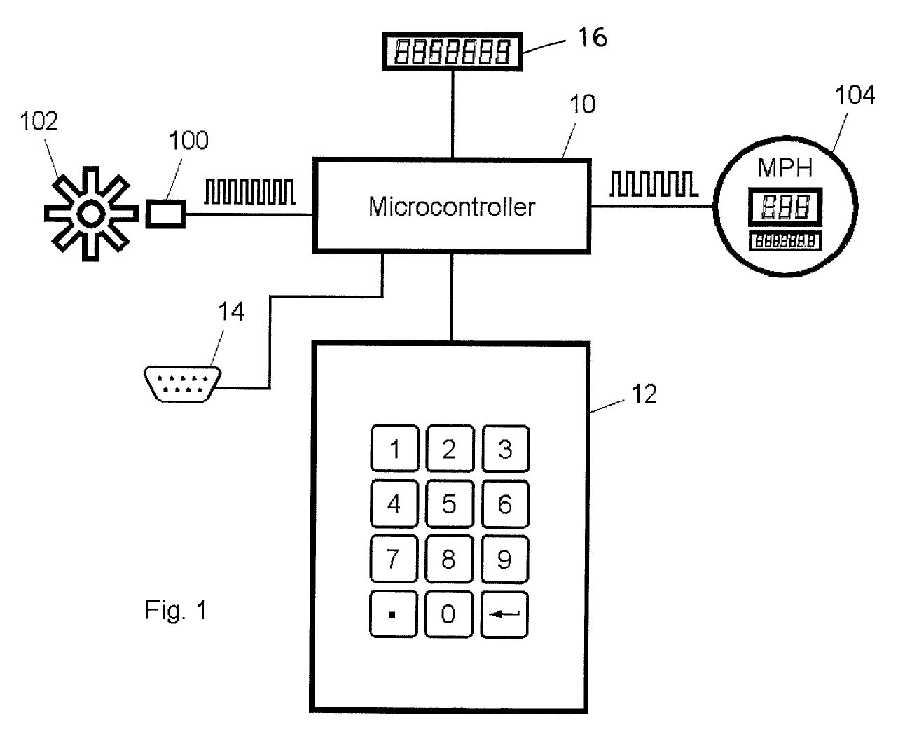

With reference now to the drawings, and particularly to FIG. 1, there is shown a schematic diagram of an electronic speedometer calibration device 1. The electronic speedometer calibration device 1 preferably includes a microcontroller 10 and an entry device. The microcontroller 10 receives an electrical speed signal from a speed sensor 100. A Parallax, model number PIC1656 microcontroller is preferably used, but other types of microcontrollers or electronic logic devices may also be used. The speed sensor 100 will sense the rotation of a gear 102 in a motor vehicle drive system, such as a transmission. The speed sensor 100 will preferably output a square wave electrical speed signal. The microcontroller 10 is instructed through a software program to change the frequency of the electrical speed signal by some multiplication factor which is determined by the user. The software program contained in the microcontroller is easily created by one skilled in the art and need not be specifically disclosed. The multiplication factor may be entered through a keypad 12, a computer download, or through any other suitable device. The computer download is preferably entered through a communication port 14.

The multiplication factor is preferably shown on a display device 16. The display of the multiplication factor ensures that the user has entered the correct number. The multiplication factor can be greater than one to compensate for modified gear ratios which increase torque. The multiplication factor can be less than one to compensate for modified gear ratios which reduce torque or correct manufacturer induced electronic speedometer inaccuracies. The software program in the microcontroller 10 will multiply the frequency of the electrical speed signal by the multiplication factor and will output a modified electrical speed signal to the electronic speedometer 104. The electronic speedometer 104 will display the corrected speed.

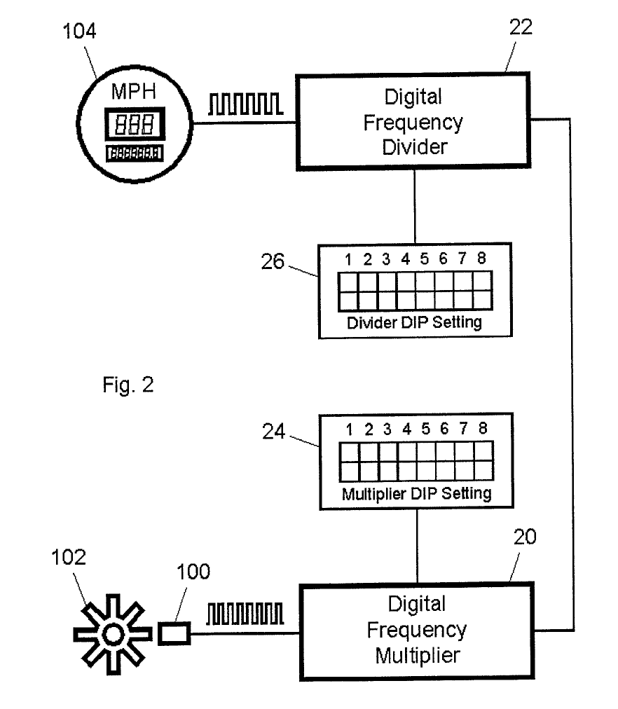

With reference to FIG. 2, a second embodiment of the electronic speedometer calibration device 2 includes a digital frequency multiplier 20, a digital frequency divider 22, a multiplier dip switch 24, and a divider dip switch 26. A digital frequency multiplier is preferably used, but other types of frequency multipliers may also be used. A digital frequency divider is preferably used, but other types of frequency dividers may also be used. The multiplier dip switch 24 defines a multiplication factor for which the frequency of the electrical speed signal is multiplied in the digital frequency multiplier 20. The divider dip switch 26 defines a division factor for which the frequency of the electrical speed signal is divided in the digital frequency multiplier 22. The speed sensor 100 will sense the rotation of a gear 102 in motor vehicle drive system, such as a transmission.

The speed sensor 100 will preferably output a square wave electrical speed signal. The electrical speed signal is preferably first input into the digital frequency multiplier 20. The frequency of the electrical speed signal is multiplied by the number set on the multiplier dip switch 24. The output of the digital frequency multiplier 20 is input into the digital frequency divider 22. The output of the digital frequency multiplier 20 is divided by the number set on the divider dip switch 26. The final multiplier factor is the multiplier number set on the multiplier dip switch 24 divided by the divider number set on the divider dip switch 26. Finally, the output of the digital frequency divider 22 is input by the electronic speedometer 104. The electronic speedometer 104 will display the corrected speed.

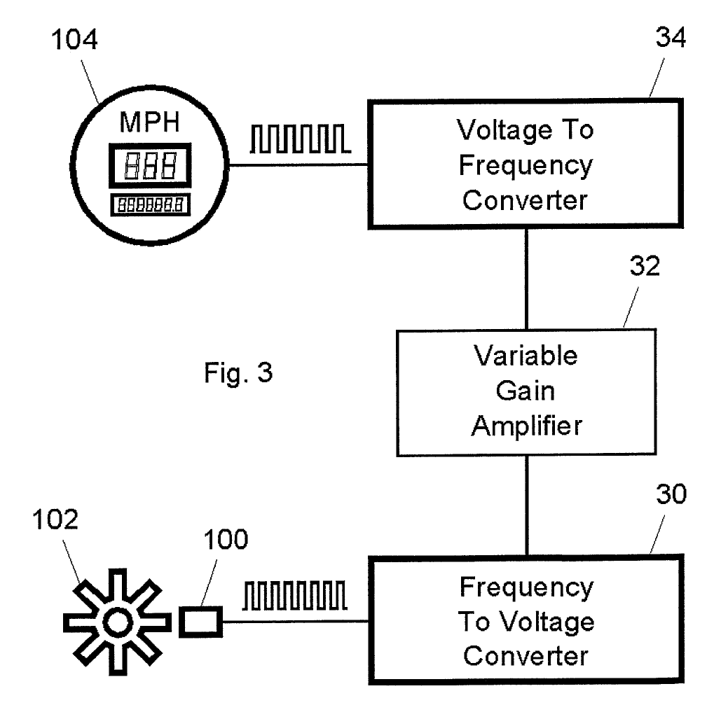

With reference to FIG. 3, a third embodiment of the electronic speedometer calibration device 3 includes a frequency to voltage converter 30, variable gain amplifier 32, and voltage to frequency converter 34. The speed sensor 100 will sense the rotation of a gear 102 in a motor vehicle drive system, such as a transmission. The speed sensor 100 will preferably output a square wave electrical speed signal. The electrical speed signal is input into the frequency to voltage converter 30. The frequency to voltage converter 30 converts the frequency of the electrical speed signal into a proportional voltage. An Anthem Electronic, model number LM2907 frequency to voltage converter 30 is preferably used, but other types of frequency to voltage converters may also be used.

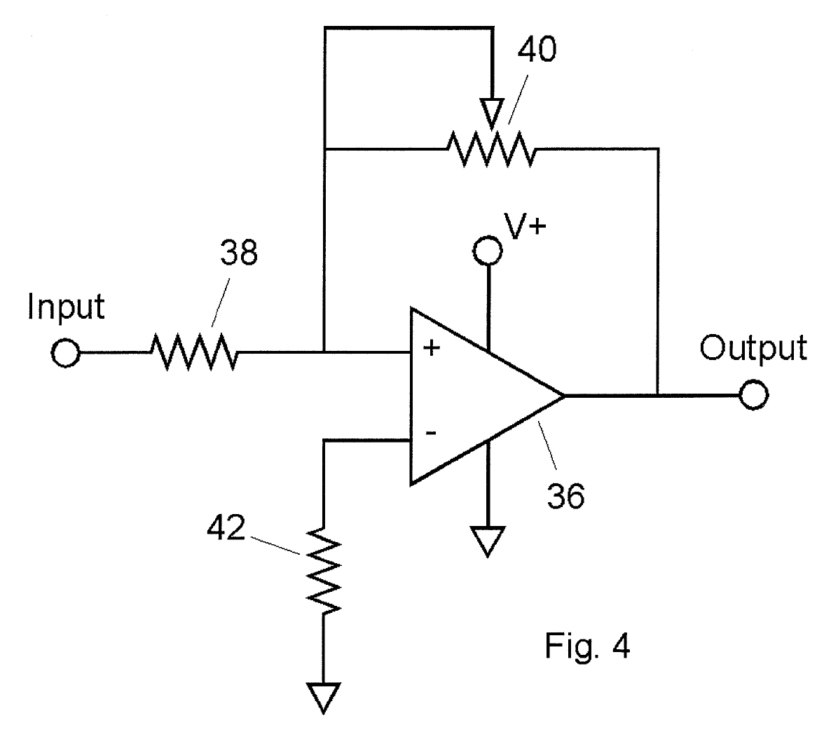

The proportional voltage is output from the frequency to voltage converter 30 into the variable gain amplifier 32. The gain of the variable amplifier may be varied by a multiplication factor which is less than one or greater than one. FIG. 4 shows a preferred embodiment of a variable gain amplifier 32. The variable gain amplifier 32 preferably includes an operational amplifier 36, input resistor 38, a potentiometer 40, and a ground resistor 42. The gain of the variable gain amplifier 32 is modified by adjusting the potentiometer 40. Any suitable model of operational amplifier may be used. However, other variable gain amplifier circuits may also be used.

The proportional voltage is multiplied by the gain of the variable gain amplifier 32 and input into the voltage to frequency divider 34. The voltage to frequency converter 34 converts the modified proportional voltage into a proportional frequency. The proportional frequency is equal to the frequency of the speed signal multiplied by the gain set on the variable gain amplifier. An Anthem Electronic, model number LM331N voltage to frequency converter 34 is preferably used, but other types of voltage to frequency converters may also be used. The proportional frequency is input by the electronic speedometer and the corrected speed will be displayed.

The electronic speedometer calibration device 1-3 may be implemented as an add-on-unit to an existing motor vehicle, or made as an integral part of a new motor vehicle. The electronic speedometer calibration device 1-3 may be added to the new motor vehicle as a separate unit, or combined with some other component on the new motor vehicle. Three embodiments of electronic speedometer calibration devices are disclosed, but other circuits which provide the same function may also be used.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of correcting the speed displayed on an electronic speedometer, comprising the steps of:
(a) determining a multiplication factor;
(b) obtaining an electrical speed signal from a motor vehicle drive system;
(c) multiplying a frequency of said electrical speed signal by said multiplication factor to produce a modified electrical speed signal; and
(d) inputing said modified electrical speed signal into the electronic speedometer.

2. The method of correcting the speed displayed on an electronic speedometer, further comprising:
a microcontroller receiving said electrical speed signal, said microcontroller multiplying the frequency of said electrical speed signal by said multiplication factor, said microcontroller outputing said modified electrical speed signal.

3. The method of correcting the speed displayed on an electronic speedometer, further comprising:
a frequency multiplier receiving said electrical speed signal and multiplying the frequency thereof by a multiplication factor, said output of said frequency multiplier being input into a frequency divider, said frequency divider dividing said output of said frequency multiplier to produce said modified electrical speed signal.

4. The method of correcting the speed displayed on an electronic speedometer, further comprising:
a frequency to voltage converter receiving said electrical speed signal, a variable gain amplifier inputing a proportional voltage from said frequency to voltage converter, a voltage to frequency converter receiving the output of said variable gain amplifier, said voltage to frequency converter outputing said modified electrical speed signal.

5. An electronic speedometer calibration device comprising:
a microcontroller receiving an electrical speed signal from a motor vehicle drive system; and
an entry device capable of entering a multiplication factor into said microcontroller, said microcontroller multiplying the frequency of said electrical speed signal by said multiplication factor to produce a modified electrical speed signal, an electronic speedometer receiving said modified electrical speed signal.

6. An electronic speedometer calibration device of claim 5, further comprising:
said multiplication factor being shown on a display device.

7. An electronic speedometer calibration device of claim 5 wherein:
said entry device being a keypad.

8. An electronic speedometer calibration device of claim 5, further comprising:
said entry device being a computer, said computer sending data to said microcontroller through a communication port.

9. An electronic speedometer calibration device comprising:
a frequency multiplier receiving an electrical speed signal from a motor vehicle and multiplying the frequency thereof by a multiplication factor; and
a frequency divider receiving the output of said frequency multiplier and dividing the frequency thereof by a dividing factor to produce said modified electrical speed signal for input into an electronic speedometer.

10. An electronic speedometer calibration device of claim 9, further comprising:
a multiplier dip switch being connected to said frequency multiplier to provide a multiplication factor; and
a divider dip switch being connected to said frequency divider to provide a dividing factor.

11. An electronic speedometer calibration device comprising:
a frequency to voltage converter receiving an electrical speed signal from a motor vehicle drive system, said frequency to voltage converter outputing a proportional voltage;
a variable gain amplifier inputing said proportional voltage and multiplying thereof by a set value of gain; and
a voltage to frequency converter receiving the output of said variable gain amplifier and outputing a modified electrical speed signal for input into an electronic speedometer.

12. An electronic speedometer calibration device of claim 11 wherein:
said variable gain amplifier including an operational amplifier, input resistor, potentiometer and, ground resistor, one input of said operational amplifier being coupled to ground through said ground resistor, the other input of said operational amplifier being coupled through said input resistor, an output of said operational amplifier being coupled to said other input through said potentiometer, said potentiometer being adjusted to set the gain of said variable gain amplifier.
